(19) United States
(12) Patent Application Publication
(10) Pub. No.: US 2006/0028154 A1
(43) Pub. Date: Feb. 9, 2006

(54) Liquid crystal display device

(76) Inventors: Hiroyuki Shimokawa, Mobara (JP); Yoshikazu Nakada, Mobara (JP); Masashi Baba, Chiba (JP); Takashi Oota, Mobara (JP); Shunsuke Morishita, Mobara (JP)

Correspondence Address: REED SMITH LLP, Suite 1400, 3110 Fairview Park Drive, Falls Church, VA, 22402, US

(21) Appl. No.: 11/189,782

(22) Filed: Jul. 27, 2005

(30) Foreign Application Priority Data
Jul. 30, 2004 (JP) 2004-223503

(51) Int. Cl. H05B 41/36

(52) U.S. Cl. 315/307

(57) ABSTRACT

The present invention can prolong a lifetime of a liquid crystal display device by suppressing the increase of a leak current attributed to the deflection of a cold cathode fluorescent lamp toward a lower frame side. An insulating member is arranged right below a cold cathode fluorescent lamp and above a lower frame. A reflecting sheet is arranged above the insulating member. The insulating member is formed in a block shape having a rectangular cross section. A fixed or more amount of distance is ensured between the cold cathode fluorescent lamp and the reflecting sheet thus suppressing the increase of the leak current.

### CROSS-REFERENCES TO RELATED APPLICATIONS

The disclosure of Japanese Patent Application JP2004-223503 filed on Jul. 30, 2004 including the specification, drawings and abstract is incorporated herein by reference in its entirety.

### BACKGROUND OF THE INVENTION

The present invention relates to a liquid crystal display device provided with a backlight which uses a cold cathode fluorescent lamp, and more particularly to a liquid crystal display device which has the structure facilitating the assembling operation and can prolong a lifetime thereof by reducing a leak current of the cold cathode fluorescent lamp.

In an image display device using a non-light-emitting type liquid crystal display panel, an electronic latent image formed on the liquid crystal display panel is visualized by providing an external illumination means. The external illumination means is formed by installing an illumination device on a back surface or on a front surface of the liquid crystal display panel except for the means which makes use of natural light. Particularly, with respect to display devices which require the high brightness, most of the display devices install the illumination device on the back surface of the liquid crystal display panel. Such an illumination device is referred to as a backlight.

The backlight is roughly classified into a side-edge-type backlight and a direct-type backlight. The side-edge-type backlight is a backlight in which a linear light source which is represented by a cold cathode fluorescent lamp (CCFL) is arranged along a side periphery of a light guide plate formed of a transparent plate and is popularly used in the display devices which are required to satisfy a demand for the reduction of thickness such as display devices for personal computers. On the other hand, in large-sized liquid crystal display devices such as display devices used for display monitors or television receiver sets, the direct-type backlight is popularly used. In the direct-type backlight, the illumination device is arranged right below the back surface of the liquid crystal display panel.

FIG. 18 is a developed perspective view for schematically explaining a constitutional example of a liquid crystal display device which uses a direct-type backlight. Here, although an upper frame is arranged above a liquid crystal display panel PNL in FIG. 18, the upper frame is omitted from FIG. 18. Further, FIG. 19 is a cross-sectional view for schematically explaining the constitution of the liquid crystal display device in which constitutional members are integrally formed. Further, FIG. 20 is a plan view which schematically explains a constitutional example of a lower frame as viewed from an optical compensation sheet side.

FIG. 19 is also a cross-sectional view taken along a line A-A in FIG. 20.

In FIG. 18 to FIG. 20, in the liquid crystal display panel LCD, a liquid crystal layer is sealed between two glass substrates, two sides of one glass substrate (usually referred to as an active matrix substrate) project from another substrate (usually referred to as a color filter substrate), and a flexible printed circuit board FPC1 which mounts a scanning signal line drive circuit chip GCH thereon and a flexible printed circuit board FPC2 on which a data signal line drive circuit chip DCH is mounted are mounted on these projecting portions. Here, as a document which discloses this kind of related art, Japanese Patent Laid-open No. 210126/2001 (document 1) can be named.

In such a liquid crystal display device, a reflecting sheet RFS is placed in the inside of a lower frame DFL, and a plurality of cold cathode fluorescent lamps CCFL are arranged in parallel above the reflecting sheet RFS thus constituting a backlight. The lower frame DFL is formed of a metal plate and also has a function of integrally forming a liquid crystal display panel LCD together with an optical compensation sheet PHS in an overlapped manner between the lower frame DFL and an upper frame UFL. With respect to a size of the liquid crystal display panel LCD, the larger the size of the liquid crystal display panel LCD becomes, a length of the cold cathode fluorescent lamps CCFL is increased. The cold cathode fluorescent lamps are constituted of a fine glass tube. Since both end portions of the cold cathode fluorescent lamp CCFL are supported on rubber bushings GBS, the larger a length of the cold cathode fluorescent lamp CCFL is increased, the deflection of cold cathode fluorescent lamp CCFL is increased. As a result, the cold cathode fluorescent lamp CCFL approaches the metal-made lower frame DFL and hence, a leak current is increased.

Further, usually, in view of the heat radiation property and a strength of the cold cathode fluorescent lamps CCFL, a surface of the lower frame which faces the cold cathode fluorescent lamp CCFL in an opposed manner is not necessarily flattened. In fact, due to an uneven shape of the lower frame, the deflected cold cathode fluorescent lamp CCFL approaches such a convex portion and the leak current is further increased in such a place.

Still further, in the liquid crystal display device, a group of optical compensation sheets in different kinds are arranged above the backlight device (between the backlight device and the liquid crystal display panel). The group of optical compensation sheets PHS of the liquid crystal display device is formed by overlapping a diffusion plate SCB, a first diffusion sheet SCS1, two prism sheets PRZ which are arranged in an intersecting manner, and a second diffusion sheet SCS2. The direct-type backlight includes a resin-made side holding frame SMLD which is mounted on a side periphery of the above-mentioned lower frame DFL having a bottom and the side periphery and is referred to as a side mold, and the group of optical compensation sheets PRZ is held by extending peripheral ends of the group of optical compensation sheets to the side holding frame SMLD. In the large-sized liquid crystal display device, the group of optical compensation sheets PRZ is also deflected toward the cold cathode fluorescent lamps CCFL side in the vicinity of the center thereof.

As shown in FIG. 19, the backlight which holds the group of optical compensation sheets PRZ is combined with the liquid crystal display panel LCD using the mold frame MLD and, thereafter, the upper frame UFL is placed on the mold frame MLD, and the upper frame UFL and the lower frame DFL are joined and integrally formed using engaging members not shown in the drawing thus forming the liquid crystal display device.

To prevent the above-mentioned cold cathode fluorescent lamps CCFL from approaching and coming into contact with the lower frame DFL by deflection, the patent document 1 discloses the structure which mounts protectors PRT on the cold cathode fluorescent lamps CCFL (see a short rectangular shape indicated by a dotted line in FIG. 19 and FIG. 20). The protector PRT is formed in a notched circular grip shape (a C-ring shape) having an opening portion at a portion thereof and is also formed of a resilient transparent member. The protector PRT is configured to grasp one lamp or these protectors PRT are configured to be integrally connected and molded to grasp a large number of lamps. In the patent document 1, there is a description that the protector PRT protects the cold cathode fluorescent lamps CCFL and, at the same time, prevents the brightness irregularities on a display surface by ensuring the positional accuracy of the arrangement of fluorescent lamps, and can prevent the lowering of the brightness and the influence on the brightness irregularities of an information display screen attributed to a shade of a lamp holder when the protector PRT is formed of the transparent material.

Further, as a measure to cope with the deflection of the group of optical compensation sheets PHS, cold cathode fluorescent lamp holders HLD are used (see an elongated rectangular shape indicated by a dotted line in FIG. 19 and FIG. 20). The cold cathode fluorescent lamp holder HLD includes, as described later in conjunction with FIG. 16 and FIG. 17, a cone-shaped body which has a proximal portion thereof mounted on a reflecting sheet RFS and brings an apex thereof into contact with a back surface of the group of optical compensation sheets PHS and, at the same time, an arm portion which holds the cold cathode fluorescent lamp CCFL. Conventionally, the above-mentioned protectors PRT and cold cathode fluorescent lamp holders HLD are, as shown in FIG. 19 and FIG. 20, arranged alternately at two positions.

Further, to meet a demand for mass production, it is necessary to overcome the situation at a small cost with a means which can be formed by an easy operation.

### BRIEF SUMMARY OF THE INVENTION

In the backlight constitution shown in FIG. 19 and FIG. 20, to ensure a distance which is at least necessary between the cold cathode fluorescent lamp CCFL and the lower frame DFL even when the cold cathode fluorescent lamp CCFL is deflected, the protector PRT is fitted on the cold cathode fluorescent lamp CCFL. Further, as shown in FIG. 20, the protector PRT is arranged in place of the holder HLD.

However, an operator manually performs the mounting of such a C-ring-like protectors PRT on the cold cathode fluorescent lamps CCFL and hence, the operation imposes a considerable labor to the operator and the operability is also poor. Further, there has been a case that the cold cathode fluorescent lamp CCFL cracks at the time of mounting the C-ring-like protector PRT on the cold cathode fluorescent lamp CCFL.

To merely ensure the distance between the cold cathode fluorescent lamp CCFL and the lower frame DFL, it may be possible to arrange a plurality of holders HLD on one cold cathode fluorescent lamp CCFL. However, in this case, the shape of the holders HLD may become complicated and hence, the blacklight becomes costly.

The above-mentioned techniques of the related art are configured such that one cold cathode fluorescent lamp CCFL is held by the holder HLD at one place and hence, the lower frame DFL and the cold cathode fluorescent lamp CCFL come close to each other whereby an electric current which flows from an inverter mounting side (a HOT side, a high voltage side) leaks and generates an overcurrent thus shortening a lifetime of the cold cathode fluorescent lamp CCFL.

The present invention has been made under such circumstances and it is an object of the present invention to provide a liquid crystal display device which can achieve a prolonged lifetime by suppressing an increase of a leak current attributed to the deflection of a cold cathode fluorescent lamp toward a lower frame side at a low cost and with the simple constitution.

The present invention arranges strip-like or belt-like insulating members above a lower frame right below the cold cathode fluorescent lamp in place of a protector which is fitted on a cold cathode fluorescent lamp. A reflecting sheet is arranged above the insulating member. To enhance the operability, it is desirable that an insulating member is arranged to traverse a plurality of cold cathode fluorescent lamps. Here, when the insulating member is formed of one (integral) strip-like insulating member which traverses all cold cathode fluorescent lamps, the operability is further enhanced. When a size of a liquid crystal display panel is further increased so that one insulating member becomes excessively long and the operability is worsened, it is desirable that the insulating member is formed of strip-like insulating members which are divided in two or more for every plurality of cold cathode fluorescent lamps. Still further, when the insulating members are arranged only on a high voltage side or are used in common as a holder by taking the arrangement position of an inverter into consideration, the insulating member is always arranged at a position close to the high voltage side. The insulating member may be constituted of an insulating member which is made of a strip-like or belt-like resin material or may by constituted by forming a reflecting sheet in a strip-like or belt-like shape.

By holding a distance between the lower frame where a leak current is most likely to occur and the cold cathode fluorescent lamp at a fixed value, it is possible to prolong a lifetime of the cold cathode fluorescent lamp. Further, since it is no more necessary to mount the C-ring-shaped protector on the cold cathode fluorescent lamps, the operation time can be shortened. Further, since the conventional protector become unnecessary, a cost for parts can be reduced. Still further, so long as the protector is used, since the protector adopts the structure which brings the protector into contact with the cold cathode fluorescent lamp, the cold cathode fluorescent lamp becomes yellowish as time elapses thus considerably influencing the light emitting efficiency thereof. According to the present invention, it is possible to suppress the lowering of the light emitting efficiency of the cold cathode fluorescent lamp along with the lapse of time.

### BRIEF DESCRIPTION OF THE DRAWING

FIG. 1 is a cross-sectional view corresponding to FIG. 19 showing the constitution of an embodiment 1 of a liquid crystal display device according to the present invention;

FIG. 2 is a view of a backlight shown in FIG. 1 as viewed from an upper surface thereof;

FIG. 3 is an enlarged cross-sectional view of a portion B shown in FIG. 1 and FIG. 2;

FIG. 4 is a cross-sectional view similar to FIG. 3 for explaining an embodiment 2 of the liquid crystal display device according to the present invention;

FIG. 5 is a cross-sectional view similar to FIG. 4 for explaining an embodiment 3 of the liquid crystal display device according to the present invention;

FIG. 6 is a view of a backlight as viewed from an upper surface thereof and similar to FIG. 2 for explaining an embodiment 4 of the liquid crystal display device according to the present invention;

FIG. 7 is a view similar to FIG. 2 for explaining the embodiment 5 of the liquid crystal display device according to the present invention;

FIG. 8 is a view similar to FIG. 2 for explaining the embodiment 6 of the liquid crystal display device according to the present invention;

FIG. 9 is a view similar to FIG. 2 for explaining the embodiment 7 of the liquid crystal display device according to the present invention;

FIG. 10 is a view for explaining the relationship between a distance between a lower frame and a cold cathode fluorescent lamp and a leak current;

FIG. 11 is a view for explaining the relationship between a distance between a lower frame and a cold cathode fluorescent lamp and a starting voltage;

FIG. 12 is a view showing another embodiment of the present invention;

FIG. 13 is a view showing another embodiment of the present invention;

FIG. 14 is a view showing another embodiment of the present invention;

FIG. 15 is a view showing another embodiment of the present invention;

FIG. 16 is an explanatory view of a holder which is installed for suppressing the sagging of a group of optical sheets while holding the cold cathode fluorescent lamp;

FIG. 17 is an explanatory view of an arrangement of a holder with respect to the lower frame, a reflecting sheet and the cold cathode fluorescent lamp;

FIG. 18 is a developed perspective view for schematically explaining a constitutional example of a liquid crystal display device which uses a direct-type backlight;

FIG. 19 is a cross-sectional view for schematically explaining the constitution of the liquid crystal display device with which constitutional members are integrally formed; and

FIG. 20 is a plan view for schematically explaining a constitutional example of the lower frame as viewed from an optical compensation sheet side.

### DETAILED DESCRIPTION OF THE INVENTION

Preferred embodiments of the present invention are explained in detail in conjunction with drawings which show embodiments.

### Embodiment 1

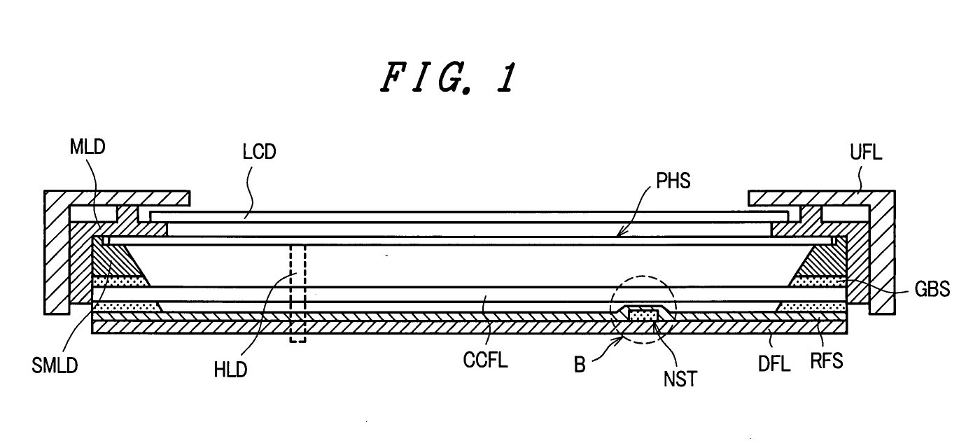

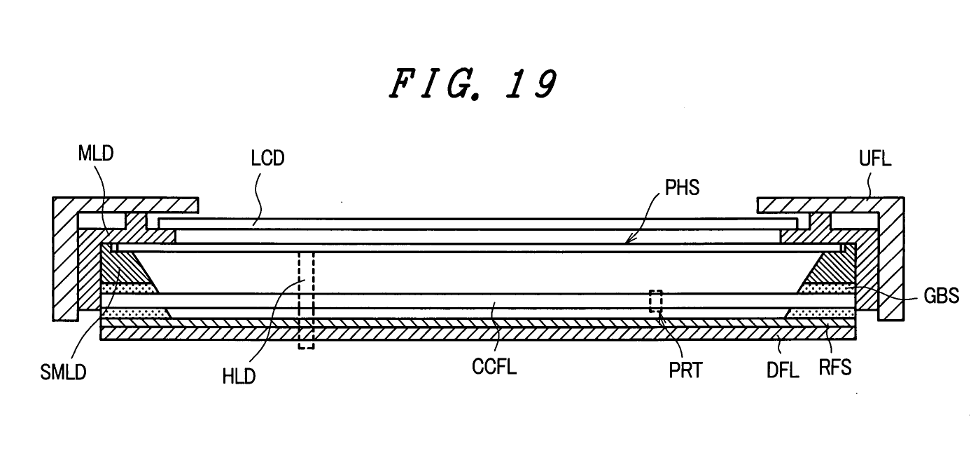

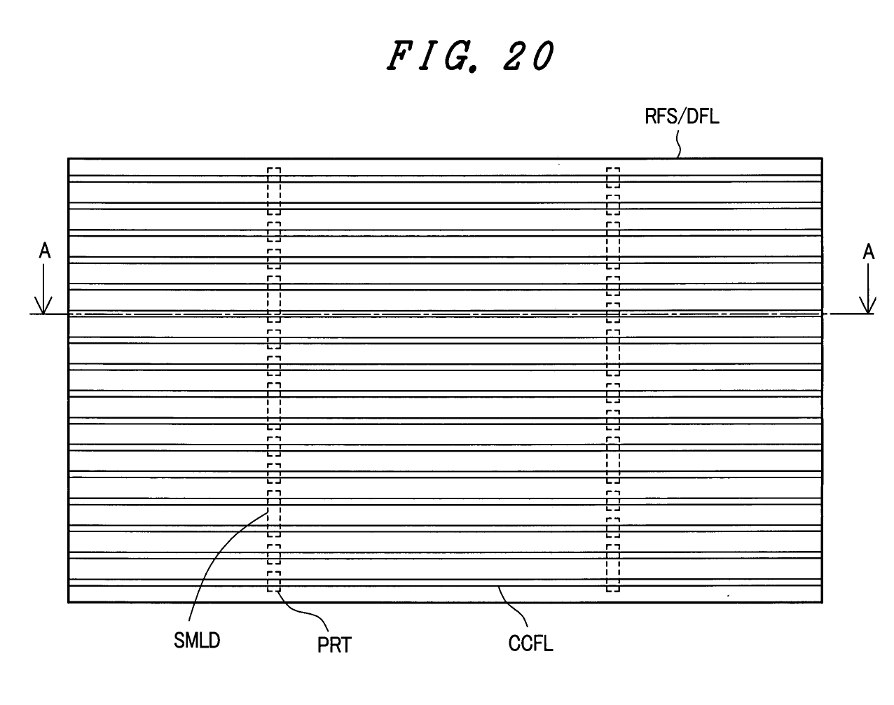

FIG. 1 is a cross-sectional view corresponding to FIG. 19 showing the constitution of an embodiment 1 of a liquid crystal display device according to the present invention. Symbols equal to the symbols used in FIG. 19 indicate the identical functional parts. In the liquid crystal display device, a backlight is arranged on a back surface of a liquid crystal display panel LCD by way of a group of optical compensation sheets PHS. The backlight is configured such that a reflecting sheet RFS is placed in the inside of a lower frame DFL and a plurality of cold cathode fluorescent lamps CCFL are arranged in parallel to each other above the reflecting sheet RFS. The lower frame DFL is formed of a metal plate and also has a function of overlapping and integrating the liquid crystal display panel LCD with the group of optical compensation sheets PHS between the lower frame DFL and an upper frame UFL which is also formed of a metal plate. The cold cathode fluorescent lamps CCFL are mounted in a state that both end portions thereof are supported on a side mold SMLD using rubber bushings GBS.

The group of optical compensation sheets PHS is held between the side mold SMLD and a mold frame MLD which is combined with the side mold SMLD. The mold frame MLD which accommodates the liquid crystal display panel LCD therein is covered with the upper frame UFL from above, and the upper frame UFL is joined and integrally formed with the lower frame DFL by means of engaging means not shown in the drawing thus obtaining the liquid crystal display device.

In the embodiment 1, insulating members NST are arranged right below the cold cathode fluorescent lamps CCFL and above the lower frame DFL, and the reflecting sheet RFS is arranged above the insulating members NST. The insulating members NST are formed in a strip-like shape having a rectangular cross section. Due to such a constitution, it is possible to ensure a fixed distance or more between the cold cathode fluorescent lamps CCFL and the reflecting sheet RFS.

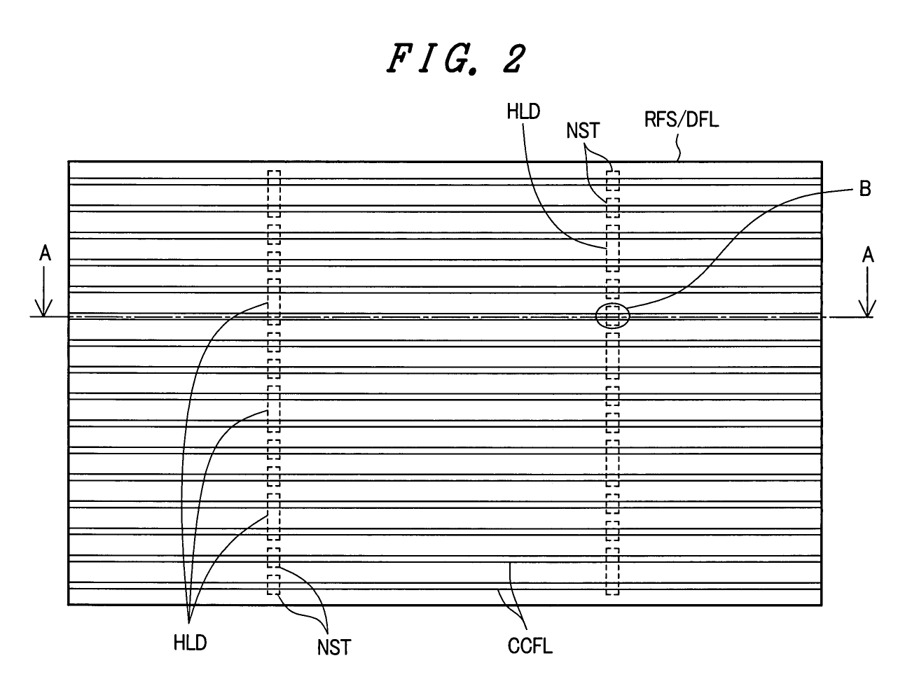

FIG. 2 is a view showing the backlight shown in FIG. 1 from above. As shown in FIG. 2, the insulating members NST are arranged corresponding to positions where the protectors PRT are arranged in FIG. 19. Here, FIG. 1 is a view which is a cross-sectional view taken along a line A-A in FIG. 2 and includes portions other than the backlight.

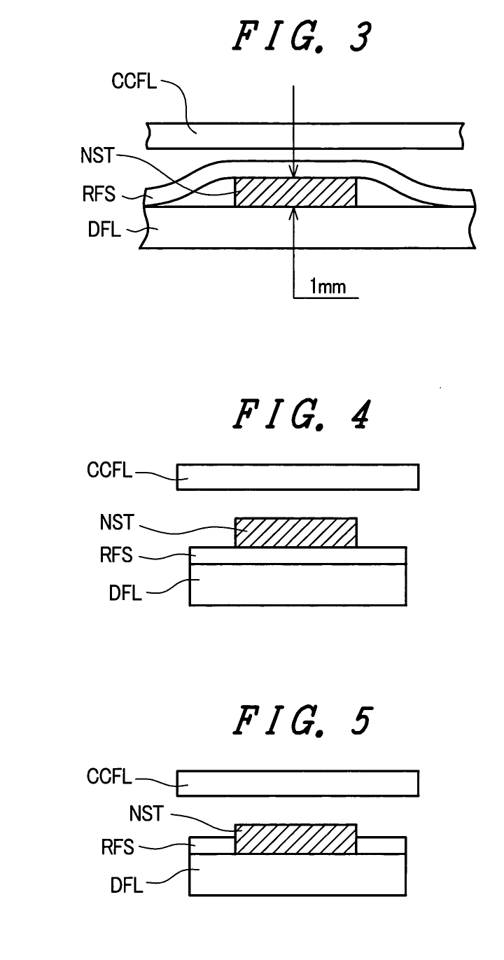

FIG. 3 is a cross-sectional view showing a portion B in FIG. 1 and FIG. 2 in an enlarged manner. As shown in FIG. 3, the insulating members NST are arranged at desired positions (specific positions being described later) on the lower frame DFL, and the reflecting sheet RFS is arranged above the insulating members NST. Due to such a constitution, even when the cold cathode fluorescent lamps CCFL are deflected toward the lower frame DFL side or the lower frame DFL is partially formed in a projecting shape, a space between the cold cathode fluorescent lamps CCFL and the lower frame DFL is ensured by at least a distance corresponding to a thickness of the insulating members NST. Accordingly, it is possible to prevent the increase of a leak current.

Further, by fixing the insulating members NST to the lower frame DFL, there is no possibility that the insulating members NST are displaced and hence, it is possible to easily arrange the insulating members NST at desired positions. In such a state, in view of the efficiency of the cold cathode fluorescent lamps CCFL and the like, it is desirable to maintain the distance between the cold cathode fluorescent lamps CCFL and the reflecting sheet RFS such that the cold cathode fluorescent lamps CCFL and the reflecting sheet RFS are not brought into contact with each other.

The insulating members NST are, for example, made of silicon rubber which adheres a tacky adhesive material to either one or both surfaces thereof and has a thickness of 1 mm, for example. The insulating members NST are laminated to the lower frame DFL at desired positions.

In the embodiment 1, the operability is remarkably enhanced compared to the case in which the C-ring-shaped holders are mounted on the cold cathode fluorescent lamps and the desired leak current prevention can be realized without increasing the holders and hence, it is possible to provide the liquid crystal display device at a low cost.

### Embodiment 2

FIG. 4 is a cross-sectional view similar to FIG. 3 for explaining an embodiment 2 of the liquid crystal display device according to the present invention. In the embodiment 2, the insulating members NST are arranged above the reflecting sheet RFS. The shape, the material and the thickness of the insulating members NST are substantially equal to the shape, the material and the thickness of the insulating members NST of the embodiment 1. In such a constitution, it is desirable that the reflecting member is arranged by coating, for example, above the insulating members NST which are mounted for reflecting light from the cold cathode fluorescent lamps CCFL. Also in the embodiment 2, in the same manner as the embodiment 1, the operability is remarkably enhanced compared to the case in which the C-ring-shaped holders are mounted on the cold cathode fluorescent lamps and the desired leak current prevention can be realized without increasing the holders and hence, it is possible to provide the liquid crystal display device at a low cost.

### Embodiment 3

FIG. 5 is a cross-sectional view similar to FIG. 4 for explaining an embodiment 3 of the liquid crystal display device according to the present invention. In the embodiment 2, portions of the reflecting sheet RFS where the insulating members NST are arranged are hollowed and the insulating members NST are arranged in the hollowed holes. Also in the embodiment 3, in the same manner as the embodiment 2, it is desirable to arrange the reflecting member on the insulating members NST. A shape, a material and a thickness of the insulating members NST are equal to the shape, the material and the thickness of the insulating members NST in the embodiments 1, 2.

Also in the embodiment 3, in the same manner as the embodiment 1, the operability is remarkably enhanced compared to the case in which the C-ring-shaped holders are mounted on the cold cathode fluorescent lamps and the desired leak current prevention can be realized without increasing the holders and hence, it is possible to provide the liquid crystal display device at a low cost.

Next, embodiments in which insulating materials are arranged above the lower frame or above the reflecting sheet are explained. In the embodiments described hereinafter, the arrangement structure of the insulating members NST which are arranged below the cold cathode fluorescent lamps may have any one of the cross sections shown in FIG. 3, FIG. 4 or FIG. 5.

### Embodiment 4

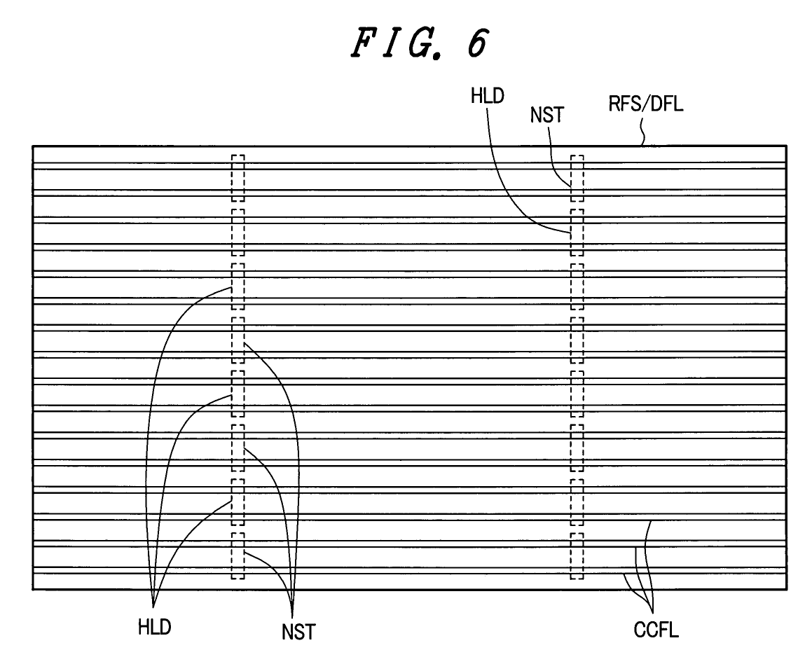

FIG. 6 is a view of a backlight as viewed from an upper surface thereof and similar to FIG. 2 for explaining an embodiment 4 of the liquid crystal display device according to the present invention. In the embodiment 4, for every two cold cathode fluorescent lamps CCFL which are arranged in parallel to each other, a strip-like insulating member NST is arranged. Further, the neighboring one cold cathode fluorescent lamps CCFL out of the respective two sets of cold cathode fluorescent lamps CCFL are held by the holder HLD. That is, the insulating member NST and the holders HLD are alternately arranged with respect to two cold cathode fluorescent lamps CCFL. The insulating member NST and the holder HLD are arranged in two rows in total at positions away from a center portion and close to both end sides in the longitudinal direction of the cold cathode fluorescent lamps CCFL in a state that the insulating member NST and the holder HLD are arranged alternately in each row.

Also in the embodiment 4, in the same manner as the embodiment 1, the operability is remarkably enhanced compared to the case in which the C-ring-shaped holders are mounted on the cold cathode fluorescent lamps and the desired leak current prevention can be realized without increasing the holders and hence, it is possible to provide the liquid crystal display device at a low cost.

### Embodiment 5

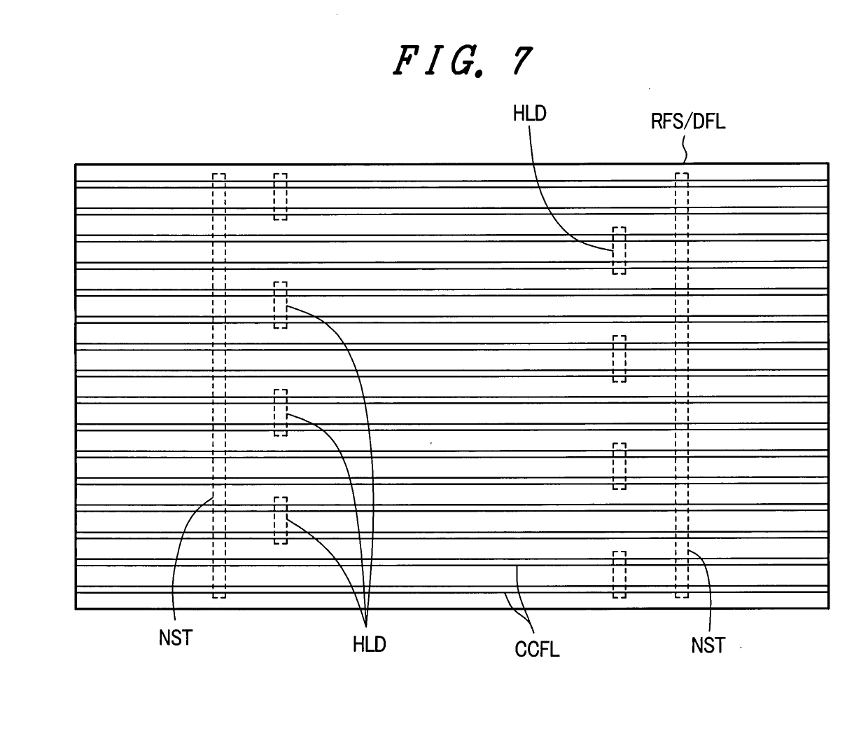

FIG. 7 is a view similar to FIG. 2 for explaining the embodiment 5 of the liquid crystal display device according to the present invention. In the embodiment 5, one strip-like insulating member NST is arranged in two rows in total at positions away from a center portion and close to both end sides in the longitudinal direction of the cold cathode fluorescent lamps CCFL in a state that the insulating member NST traverses in the transverse direction of a large number (inclusive of three) of cold cathode fluorescent lamps CCFL (for example, all cold cathode fluorescent lamps CCFL arranged in parallel) With respect to the respective insulating members NST, the holders HLD similar to the holder HLD in the above-mentioned embodiment are arranged on the center side in the longitudinal direction of the cold cathode fluorescent lamps CCFL. In the embodiment 7, the holders HLD are arranged such that the respective holders HLD hold two cold cathode fluorescent lamps CCFL alternately at positions close to the respective insulating member NST.

According to the embodiment 5, the insulting material NST is arranged in common with respect to the large number of cold cathode fluorescent lamps CCFL. Although the mounting of the insulating members NST is manually performed by an operator, compared to the embodiment shown in FIG. 6, according to the case of the embodiment shown in FIG. 7, the number of mounting operations can be remarkably reduced thus providing the liquid crystal display device at a lower cost.

### Embodiment 6

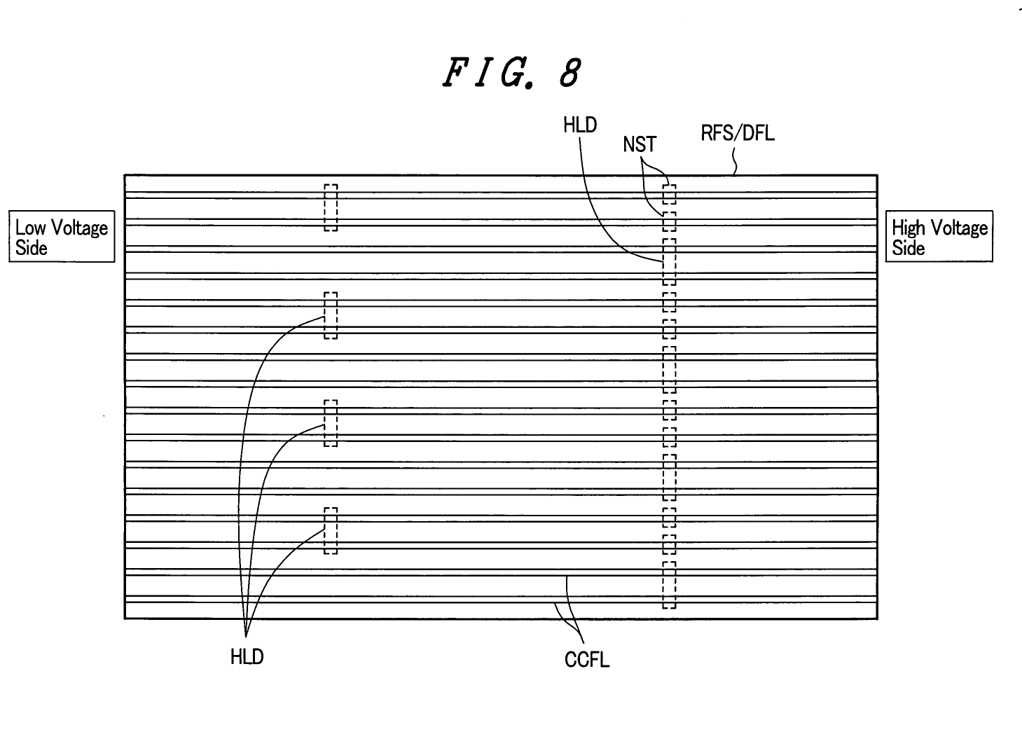

FIG. 8 is a view similar to FIG. 2 for explaining an embodiment 6 of the liquid crystal display device according to the present invention. The embodiment 6 is characterized by the arrangement of the insulating members NST which is devised by taking the mounting position of an inverter connected to the cold cathode fluorescent lamps CCFL into consideration.

In FIG. 8, in a state that a viewer faces the drawing, a high voltage side (a hot side) is arranged at a right side and a low voltage side (a cold side) is arranged at a left side. Usually, the inverter is arranged close to the high voltage side.

Since a large quantity of leak current is generated on the high voltage side, in the embodiment 6, at a position close to the low voltage side, the holders HLD are arranged in a row in a state that the holder HLD is mounted on two cold cathode fluorescent lamps CCFL and the holders HLD are arranged every two cold cathode fluorescent lamps CCFL, while at a position close to the high voltage side, the holders HLD are alternately arranged with respect to the holders HLD at the position close to the low voltage side in a row in a state that the holder HLD is mounted on two cold cathode fluorescent lamps CCFL and the holders HLD are arranged every two cold cathode fluorescent lamps CCFL. Further, with respect to the cold cathode fluorescent lamps CCFL which are not held by the holders HLD, the insulating members NST are arranged for the respective cold cathode fluorescent lamps CCFL on the same row as the holders HLD.

Due to such a constitution, in addition to the advantageous effects brought about by the constitutions of the above-mentioned respective embodiments, time and efforts for arranging the insulating members NST can be halved thus providing the liquid crystal display device which exhibits the improved productive efficiency.

### Embodiment 7

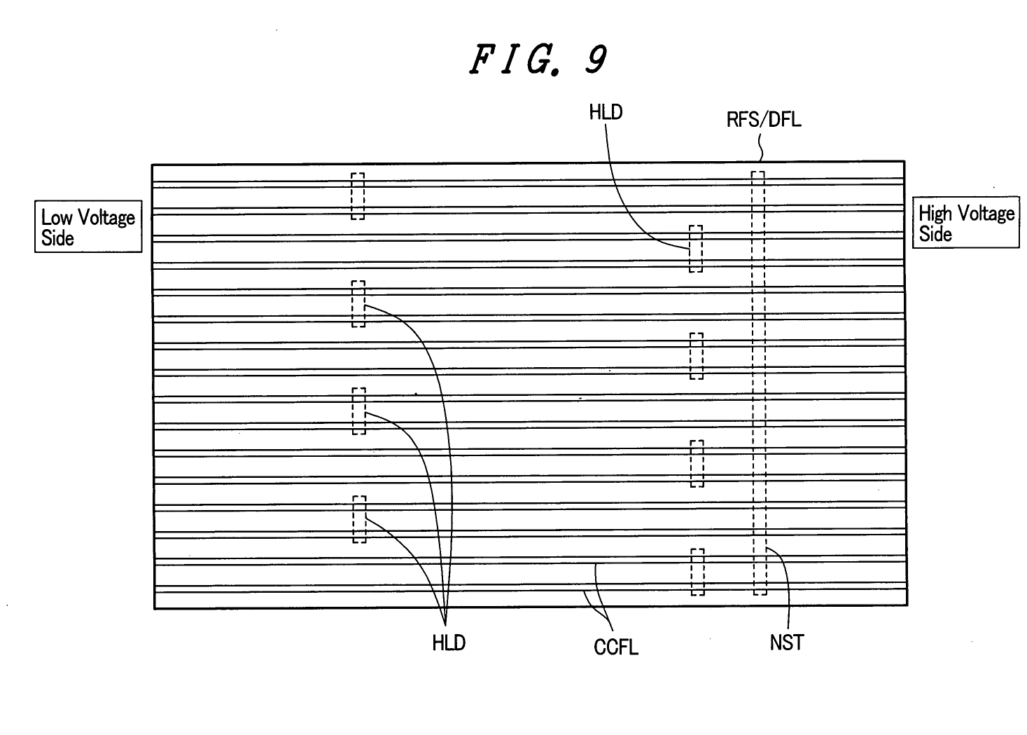

FIG. 9 is a view similar to FIG. 2 for explaining an embodiment 7 of the liquid crystal display device according to the present invention. In the embodiment 6, in the same manner as FIG. 8, in a state that a viewer faces the drawing, a high voltage side is set on a right side and a low voltage side is set on a left side. Also in FIG. 9, only holders HLD which hold the cold cathode fluorescent lamps CCFL are arranged at a position close to the low voltage side. The holders HLD on the low voltage side are arranged for every two other cold cathode fluorescent lamps CCFL. Corresponding to every two cold cathode fluorescent lamps CCFL which are arranged close to the respective two cold cathode fluorescent lamps CCFL held by the holders HLD on the low voltage side, the holders HLD are arranged also on the high voltage side in a row. Further, on the high-voltage side, at a position closer to the high-voltage side than the row of the holders HLD, the insulating members NST which form one strip shape is arranged with respect to all cold cathode fluorescent lamps CCFL.

In this embodiment 7, in addition to the advantageous effects brought about by the above-mentioned respective embodiments, by forming the insulating members NST into one strip shape, time and efforts for performing the operation can be remarkably reduced thus providing the liquid crystal display device which exhibits the favorable productive efficiency.

Here, the relationship between a distance from the cold cathode fluorescent lamps CCFL to the lower frame DFL and a high-voltage-side tube current is explained. As a standard of the cold cathode fluorescent lamp, a maximum tube current: 7.5 (mArms) is set. That is, when the maximum tube current which is 7.5 (mArms) or more flows, the guaranteed life time is lowered.

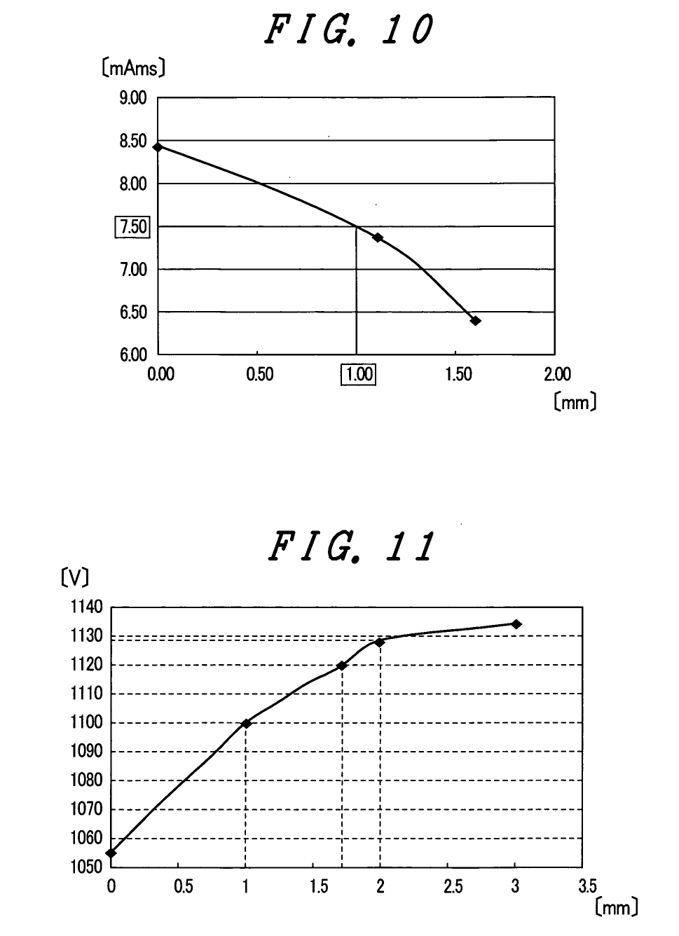

FIG. 10 is a view for explaining the relationship between the lower frame-cold cathode fluorescent lamp distance and the leak current, wherein the lower frame-cold cathode fluorescent lamp distance (mm) is taken on an axis of abscissas and the tube current (mArms) which flows in the high voltage side of the cold cathode fluorescent lamp is taken on an axis of ordinates. The cold cathode fluorescent lamp used here has a tube outer diameter of 3 mm and a tube length of 709 mm. It is understood from FIG. 10, when the maximum tube current (=leak current) is 7.5 (mArms), the lower frame-cold cathode fluorescent lamp distance is 1 mm. From such reading, it is understood that it is necessary to set the lower frame-cold cathode fluorescent lamp distance to 1 mm or more.

FIG. 11 is a view for explaining the relationship between the lower frame-cold cathode fluorescent lamp distance and a starting voltage (when an ambient temperature is 25° C.), wherein the lower frame-cold cathode fluorescent lamp distance (mm) is taken on an axis of abscissas and the starting voltage (V) is taken on an axis of ordinates. From a viewpoint of the starting voltage, it is understood from FIG. 11 that the closer lower frame-cold cathode fluorescent lamp distance is, the starting voltage is lowered. In view of FIG. 10 and FIG. 11, it is desirable to set the lower frame-cold cathode fluorescent lamp distance to 1 mm.

The length of the insulating member NST is set to approximately 300 mm. This length can be changed depending on the number of the cold cathode fluorescent lamps CCFL in use. In the respective embodiments of the present invention, the length of the insulating member NST is set to 300 mm mainly at portions where the leak current value becomes maximum and the length of the insulating member NST is not limited to such a length.

A width of the insulating member NST is set to approximately 2 mm. This is because that the position where the leak current value becomes maximum is substantially determined at a lower end of the cold cathode fluorescent lamp and hence, it is sufficient to arrange the insulating member NST right below the lower end and the operability can be enhanced. Further, although it may be possible to obtain an advantageous effect that the leak current value can be further decreased by widening the width, in the liquid crystal display device which arranges insulating members NST below the reflecting sheet RFS, the reflecting sheet may be swelled and may give an adverse influence to optical characteristics.

Further, the increase of the width of the insulating member NST pushes up a manufacturing cost thereof higher than a manufacturing cost of the CFL protector and hence, the width of the insulating member NST is set to 2 mm. However, depending on the specification of the backlight, the width, the length, the thickness and the shape of the insulating member can be freely changed. The location where the large leak current flows resides on an inverter mounting side (high voltage side) with respect to the center of the backlight. As shown in the drawings of the respective embodiments, at the position shifted leftward from the inverter mounting side by approximately ¼, the insulating members are laminated in a vertical symmetry in the drawing. Here, the leak current I can be obtained by a following formula. That is,
I=2πVfC

I: leak current, V: tube voltage, f: frequency, C: electrostatic capacitance.

Further, the electrostatic capacitance C is obtained by a following formula. That is,
C=ε·S/d

ε: dielectric constant, S: area of lower frame right below cold cathode fluorescent lamp CCFL, d: cold cathode fluorescent lamp-lower frame distance.

In view of the above, since the leak current is influenced by the area of the lower frame right below the cold cathode fluorescent lamp, it is possible to suppress the leak current by decreasing the area of the lower frame at a position right below the cold cathode fluorescent lamp.

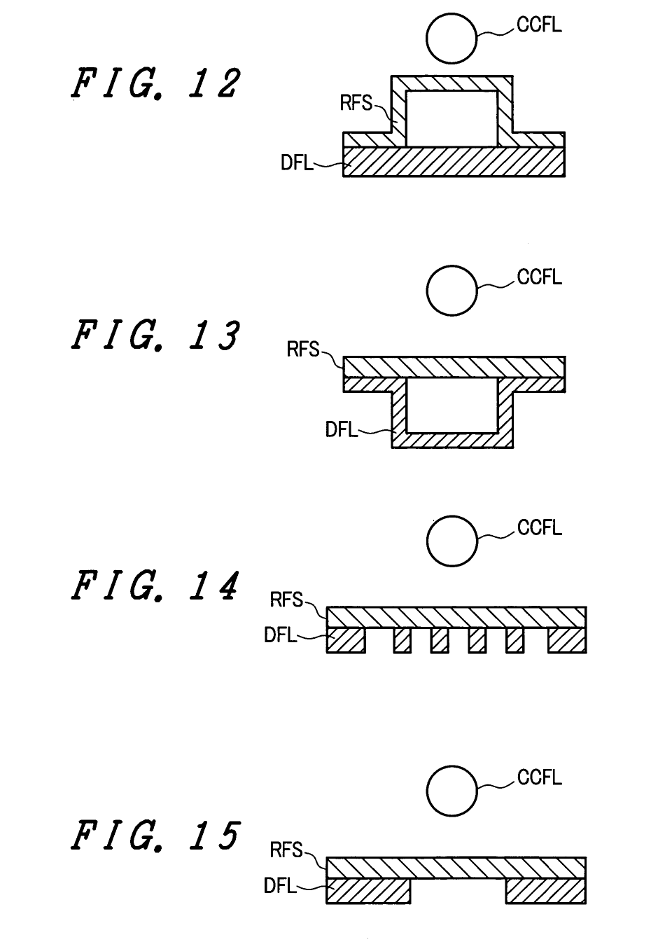

FIG. 12, FIG. 13, FIG. 14 and FIG. 15 are views showing other embodiments of the present invention. These drawings are views which show portions corresponding to the above-mentioned FIG. 3, FIG. 4 or FIG. 5. In FIG. 12, in place of using the insulating members NST, the reflecting sheet RFS which is usually formed of an insulating material is formed on the reflecting sheet RFS in a projecting manner thus providing a space EMP between the reflecting sheet RFS and the lower frame DFL whereby a distance between the cold cathode fluorescent lamp CCFL and the metal-made lower frame DFL is assured at a given value. In this case, a portion which is formed in a projecting manner constitutes an effective insulating member NST.

In FIG. 13, a metal-made lower frame DFL is formed in a downwardly projecting shape (a recessed shaped) so as to increase a distance between a cold cathode fluorescent lamp CCFL and the lower frame DFL thus assuring a desired distance.

FIG. 14 shows the constitution which can cope with a leak current by forming a plurality of slits in a lower frame DFL arranged right below a cold cathode fluorescent lamp CCFL thus substantially reducing an area that the lower frame DFL and the cold cathode fluorescent lamp CCFL are overlapped to each other.

FIG. 15 shows the constitution which can cope with a leak current by forming a hole in the lower frame DFL thus theoretically infinitely expanding a distance right below the cold cathode fluorescent lamp CCFL between the lower frame DFL and the cold cathode fluorescent lamp CCFL.

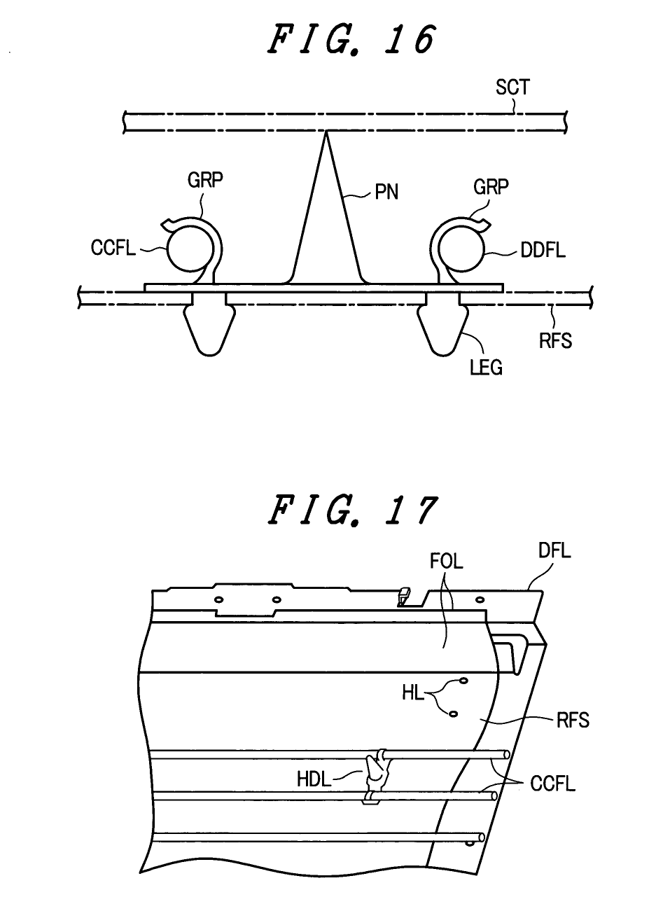

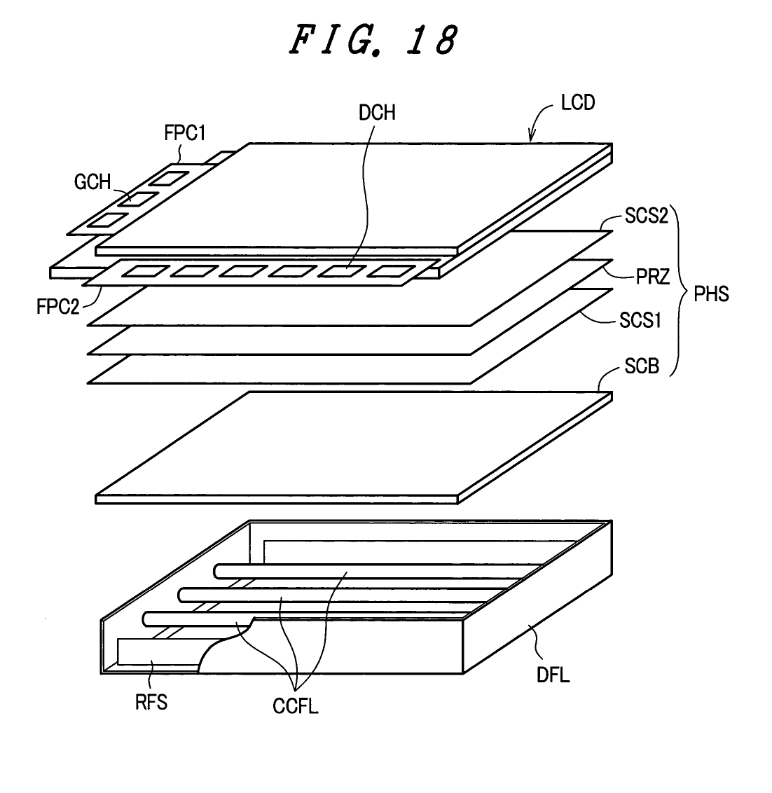

FIG. 16 is an explanatory view of holders for suppressing sagging of a group of optical sheets while holding cold cathode fluorescent lamps. Further, FIG. 17 is an explanatory view of arrangement of holders HLD with respect to a lower frame DFL, a reflecting sheet RFS and cold cathode fluorescent lamps CCFL. Although the explanation has been made also in the above-mentioned respective embodiments, the reflecting sheet RFS is placed on an inner bottom of the lower frame DFL, and cold cathode fluorescent lamps CCFL which have both ends thereof supported by rubber bushings are arranged above the reflecting sheet RFS.

The holder HLD is fixed to the reflecting sheet RFS by inserting leg portions LEG in holes formed in the reflecting sheet RFS. Here, it is desirable that the hole HL which allows the insertion of the leg portion LEG to the lower frame DFL arranged below the reflecting sheet RFS is provided, and the leg portion LEG is inserted and fixed to the lower frame DFL. A pair of grip portions GRP are formed on a side of the holder HLD opposite to the leg portions LEG, that is, on the cold-cathode-fluorescent-lamp-CCFL side, and a conical pin PN is formed between the grip portions GRP.

The grip portions GRP hold the cold cathode fluorescent lamp CCFL and an apex of the pin PN is brought into contact with a group of optical sheets SCT so as to suppress the sagging of the group of optical sheets SCT. By providing the holders HLD having such a constitution together with the above-mentioned insulating members NST, it is possible to achieve an object of the present invention.

Here, the above-mentioned arrangement, shapes and the like of the holders HLD and the insulating members NST can be used in suitable combinations.

What is claimed is:

1. A liquid crystal display device comprising:
a frame-like upper frame having a display window and an accommodating portion;
a liquid crystal display panel being accommodated in the frame-like display window in a state that a display region thereof is exposed;
a light source device arranged on a back surface of said liquid crystal display panel; and
a compensation sheet being arranged between said liquid crystal display panel and said light source, wherein
said light source device includes a frame-like lower frame which has a bottom portion and a peripheral portion, a reflecting sheet which is placed on said bottom portion, and a plurality of linear light sources which are arranged in parallel to each other above said reflecting sheet, and
an insulating member which prevents an approach of said linear light sources to said lower frame by a given distance or more is arranged right below said linear light sources.

2. A liquid crystal display device according to claim 1, wherein said insulating member is formed of resin.

3. A liquid crystal display device according to claim 1, wherein said insulating member is formed of a plurality of strip-like members each of which is arranged for every one or two or more cold cathode fluorescent lamps.

4. A liquid crystal display device according to claim 1, wherein said insulating member is formed of one strip-like member which is arranged in common with respect to all cold cathode fluorescent lamps.

5. A liquid crystal display device according to claim 1, wherein said insulating member is arranged over said reflecting sheet.

6. A liquid crystal display device according to claim 1, wherein said insulating member is arranged between said lower frame and said reflecting sheet.

7. A liquid crystal display device according to claim 1, wherein said insulating member is arranged in said lower frame and said insulating member is cut away at a position where said reflecting sheet is arranged over said insulating member.

8. A liquid crystal display device according to claim 1, wherein said liquid crystal display device further includes a holder together with said insulating member, wherein said holder is constituted of a grip portion which holds said linear light source and a conical pin which is brought into contact with a back surface of said optical compensation sheet.

9. A liquid crystal display device comprising a backlight device, wherein said backlight device includes a frame and a linear light source which is arranged above said frame, a insulating member is arranged in a region where said frame and said linear light source are overlapped to each other, and said insulating member is fixed to said frame side.

10. A liquid crystal display device according to claim 9, wherein a reflecting sheet is arranged on said frame in a state that said reflecting sheet covers said insulating member.

11. A liquid crystal display device according to claim 9, wherein said insulating member and said linear light source are arranged in a non-contacting manner.

12. A liquid crystal display device according to claim 10, wherein said reflecting sheet above said insulating member and said linear light source are arranged in a non-contacting manner.

13. A liquid crystal display device according to claim 9, wherein a plurality of linear light sources are arranged in parallel, and said insulating member is arranged to be orthogonal to the direction that said linear light sources extend.

14. A liquid crystal display device according to claim 13, wherein said insulating member is formed in a strip shape.

15. A liquid crystal display device according to claim 14, wherein said strip-shaped insulating member is arranged close to high-voltage side of said linear light sources.
